(19) United States
(12) Patent Application Publication
(10) Pub. No.: US 2002/0116653 A1
(43) Pub. Date: Aug. 22, 2002

(54) Programmable power supplying device for a computer

(76) Inventor: Lung-Hiang Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/788,467

(22) Filed: Feb. 21, 2001

(51) Int. Cl. G06F 1/26

(52) U.S. Cl. 713/300

(57) ABSTRACT

A programmable power supplying device for a computer includes a control and comparison IC, a memory chip, and a time oscillating circuit. The control and comparison IC can constantly compare a current time datum of the time oscillating circuit and time values set up in the memory chip to decide whether to turn on an electronic switch for the computer to be available; the computer can be provided with power through the electronic switch when the control and comparison IC turns on the switch due to a computer-available outcome of the comparison; and the computer can't have power supply when the IC turns off the switch due to a computer-not-available outcome of the comparison.

### BACKGROUND OF THE INVENTION

With the development of computer technology, people use computers in more and more areas in their daily life and work. Computers have superior ability of processing large amount of data accurately and quickly; therefore, they are very important tools in scientific researches and all sorts of companies.

Furthermore, computers can provide many entertaining functions with the development of internet, e.g. playing games, chatting with others. And, watching VCD is also what we can do with a computer nowadays.

Because computers can provide so many entertainments, many people have problems of spending too much time on them. Consequently, students forget about their study, assignments and meals, and company workers surf the web or chat on the internet covertly, delaying their jobs and costing their company unnecessary connection expenses.

To handle this problem of using computers in inappropriate time, many methods have been used, e.g. setting up available time in BIOS or the operating system. However, such methods can be broken easily by removing battery of the BIOS for a short time and putting it back, etc.

### SUMMARY OF THE INVENTION

Therefore, it is a main object of the present invention to provide a programmable power supplying device for a computer which can control the availability of the computer to overcome the problems as described in the Background.

The programmable power supplying device for a computer includes a control and comparison IC connected to a memory chip, a time oscillating circuit, and an input/output interface.

The input/output interface can receive set up time values, and send same to the memory chip through the control and comparison IC.

The control and comparison IC can compare a current time datum from the time oscillating circuit with the set up time values to decide whether to turn on an electronic switch connected thereto.

The electronic switch is connected to a rectifying circuit and the computer from two ends; thus, the computer can be provided with power through the electronic switch when the control and comparison IC turns on the electronic switch with a computer-available outcome of the comparison; and the computer can't have power supply when the IC turns off the electronic switch due to a computer-not-available outcome of the comparison.

The control and comparison IC can also alert a user to shut off the computer properly before an automatic cut-off time when a computer-not-available time is coming soon.

### BRIEF DESCRIPTION OF THE DRAWINGS

This invention will be better understood by referring to the accompanying drawings, wherein:

FIG. 1 is a block diagram of the programmable power supplying device for a computer of the present invention.

FIG. 2 is a block diagram of the controlling circuit of the programmable power supplying device for a computer of the present invention.

FIG. 3 is a flow chart of the programmable power supplying device for a computer of the present invention.

### DETAILED DESCRIPTION OF THE PREFERRED EMBODIMENT

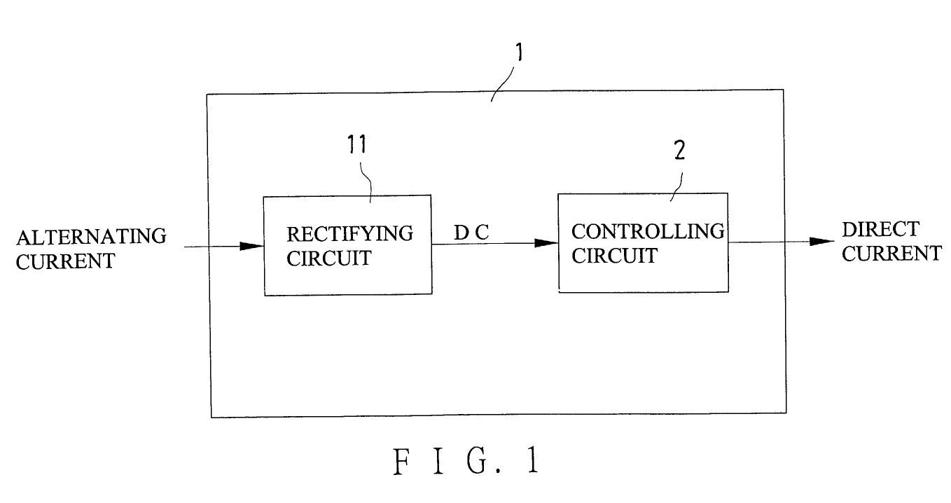

Referring to FIG. 1, a programmable power supplying device 1 for a computer of the present invention includes a rectifying circuit 11, and a controlling circuit 2; the rectifying circuit 11 turn the alternating current into a direct current which is sent to the computer through the controlling circuit 2. The connection between the power supplying device and the computer is not the subject of the present invention, and so is not detailed here.

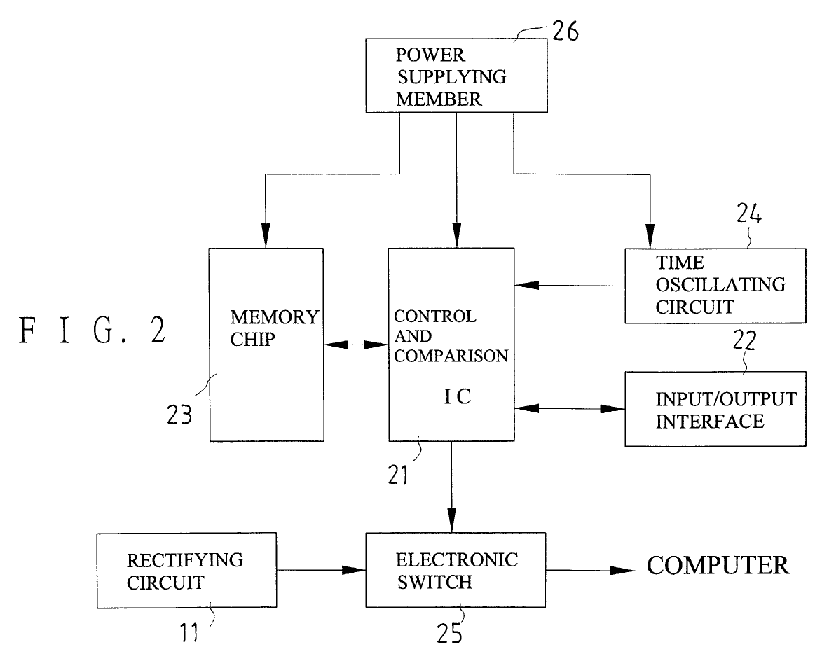

Referring to FIG. 2, the controlling circuit 2 has a control and comparison integrated circuit 21, and a memory chip 23 electrically connected to the control and comparison IC 21.

An input and output interface 22 is connected to the control and comparison IC 21 in order for data to be input the control and comparison IC 21 through it. The input and output interface 22 can be a face plate or a radio receiver which receives data from a remote controller to set up different time values. The input and output interface 22 can also be connected to a main circuit board of the computer for setting up time by means of a program, the keyboard and the monitor.

The different time values input to the control and comparison IC 21 are then stored in the memory chip 23.

A time oscillating circuit 24 is connected to the control and comparison IC 21 such that the latter can get the present time from same.

A power supplying member 26 is provided to supply power to the control and comparison IC 21 the time oscillating circuit 24 and the memory chip 23.

After the different time values are set up in the memory chip 23, the control and comparison IC 21 will get the present time, and compare same with the time values in the memory chip 23 to decide whether the computer is available or not; an electronic switch 25 of the computer is connected to, and controlled by, the control and comparison IC 21 such that same can be turned on or cut off by the IC 21 depending on the outcome of the comparison between the time values and the present time.

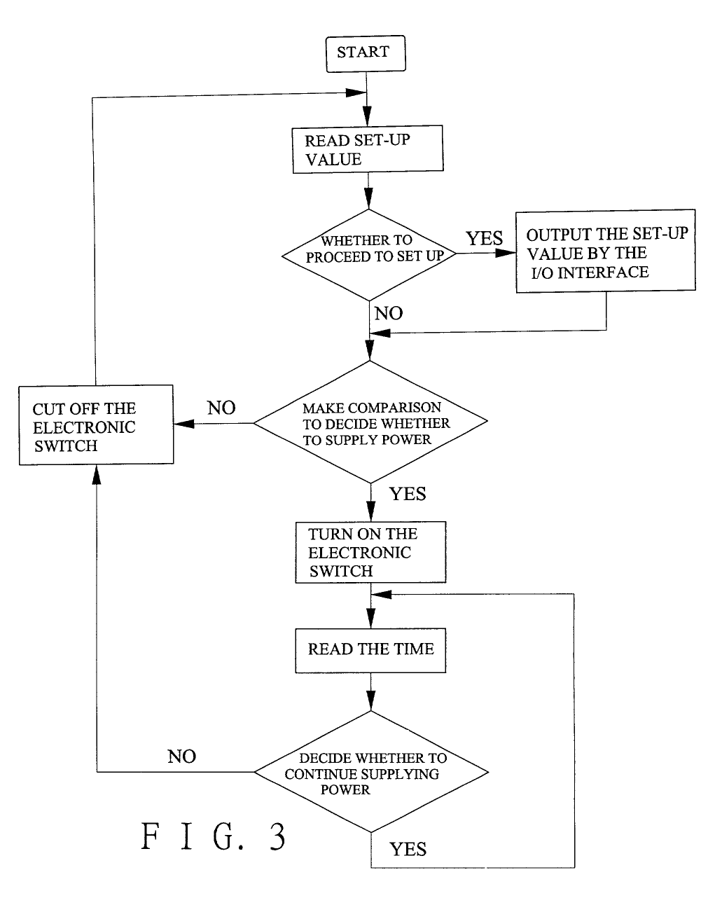

Referring to FIGS. 2 and 3, in the programmable power supplying device, the controlling circuit 2 works constantly with the power supply member 26, and will first read a set-up value to decide whether a pin number from the user entitles him to set up time values. If the user is entitled to set up time values, different time values can be set up and stored in the memory chip 23 as earlier said.

If the user doesn't want to, or can't set up time values, the control and comparison IC 21 will compare the present time with the time values to decide whether the computer is available. If the computer is available, the IC 21 will turn on the electronic switch 25 for permitting the direct current to go through from the rectifying circuit 11. If the computer is not available, the IC 21 will cut off the electronic switch 25; thus, computer can't be turned on even the power supplying device has been turned on.

The control and comparison IC 21 will compare the time with the time values in the memory chip 23 constantly in order to turn on or shut off the electronic switch 25 in proper time. If the not-available time is coming soon, the control and comparison IC 21 will alert the user to shut off the computer properly before the automatic cut-off time.

From the above description, the programmable power supplying device for a computer of the present invention can be known to have desirable features as follows:

1. Children can only play games, etc. at home during available time allowed by the parents.

2. Several time values can be set up in order for the computer to be available in several time periods. And, having the pin number, the parents or the department chief can reset the time values.

3. The programmable power supplying device is provided with several ways of setting up time values.

4. The controlling circuit has independent power supplying member and time oscillating circuit; therefore the user can't use the computer in not-available time by changing time of the computer through BIOS.

5. The users won't use the computer too long without break any more.

6. The computers of a company can be set up with a not-available time for not-working hours to prevent important data from being stolen.

What is claimed is:

1. A programmable power supplying device for a computer, comprising a control and comparison integrated circuit connected to a memory chip, a time oscillating circuit, and an input/output interface; said input/output interface being capable of receiving a plurality of set up time values, and sending same to said memory chip through said control and comparison integrated circuit; said control and comparison integrated circuit being capable of comparing a current time datum of said time oscillating circuit with said set up time values to decide whether to turn on an electronic switch connected thereto; said electronic switch being connected to a rectifying circuit from one end and said computer from other end; whereby said computer can be provided with power through said electronic switch when said control and comparison integrated circuit turns on said switch with a computer-available outcome of said comparison; and, said computer can't be provided with power through said switch when same is cut off by said integrated circuit due to computer-not-available outcome of said comparison.

2. The programmable power supplying device for a computer as claimed 1, wherein said input/output interface is a face plate permitting said time values to be set up with it.

3. The programmable power supplying device for a computer as claimed 1, wherein said input/output interface is a radio receiver for receiving data from a remote controller to set up said time values.

4. The programmable power supplying device for a computer as claimed 1, wherein said input/output interface is connected to a circuit board of said computer for permitting a user to set tip, and change said time values by means of a program and a keyboard.

5. The programmable power supplying device for a computer as claimed 1, wherein said control and comparison integrated circuit can alert a user to shut off said computer properly before an automatic cut-off time when a computer-not-available time is coming soon.

6. The programmable power supplying device for a computer as claimed 1, wherein a power supplying member is provided to supply power to said integrated circuit, said memory chip, and said time oscillating circuit.
